(19) United States
(12) Patent Application Publication
(10) Pub. No.: US 2009/0320604 A1
(43) Pub. Date: Dec. 31, 2009

(54) SENSOR SYSTEM

(75) Inventors: Andrew Robert Penman, Lowestoft (GB); Edmund David Jenkins, Woking (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: CONDUCTOR INSTALLATION SERVICES LIMITED, GREAT YARMOUTH (GB)

(21) Appl. No.: 12/375,964

(22) PCT Filed: Aug. 2, 2007
(86) PCT No.: PCT/GB07/02928

§ 371 Date: Apr. 17, 2009

(30) Foreign Application Priority Data
Aug. 4, 2006 (GB) 0615550.1

(51) Int. Cl. G01H 11/00

(52) U.S. Cl. 73/649

(57) ABSTRACT

The present invention discloses a sensor system (70) for use in the directional installation of subsea well conductors (50a, 50b, 50c). The sensor system enables the orientation and position of the conductor to be determined such that the conductor can be installed accurately into the required position.

### BACKGROUND

a. Field of the Invention

The present invention relates to a sensor system and in particular to a sensor system that may be used to determine the position of a conductor that is being driven into the sea bed. The term “conductor” in this specification and generally in the field of offshore oil and gas installations refers to a pipe which is the first pipe to enter the seabed when a well is to be drilled, through which subsequent drilling of the well takes place and form which well casings are suspended. The conductor forms the foundation of the well.

b. Related Art

In order to increase the efficiency with which oil or gas is extracted from a known reserve by a single platform or rig, it is known to use directional driving to enable conductors to be installed into their selected positions. Inaccurate installation can lead to conductors deviating from a desired path or even colliding with each other, either of which events hinders the successful completion of a well.

### SUMMARY OF THE INVENTION

According to a first aspect of the present invention there is provided a conductor for subsea installation, the conductor comprising an orientation sensor, the orientation sensor comprising one or more sensor means for, in use, determining the orientation of the conductor when being installed.

The orientation sensor is preferably a single sensor which can sense both inclination and azimuth parameters of the position of the sensor. Both inclination and azimuth are related to the vertical axis of the conductor before it enters the sea bed. The sensor provides a continual indication of the position of the sensor from which the position of the conductor string can be deduced, during the driving operation.

The conductor is adapted to be driven into the ground, by vertical forces acting downward on the conductor itself. These forces will partly be provided by the effect of gravity on the weight of the conductor, but primarily by hammer action on the conductor.

The conductor will preferably include a drive shoe at its leading end, and the sensor may be provided in the drive shoe (preferably in a cavity in the wall of the drive shoe).

The conductor may comprise more than one orientation sensor. Preferably the or each orientation sensor is received within a cavity formed within a wall of the conductor. The conductor may have more than one cavity and one orientation sensor may be received within each of the cavities formed within the conductor.

The (or each) sensor preferably comprises a 2D inclination sensor (preferably a bi-axial accelerometer, typically measuring ±15° from the vertical in two orthogonal planes), a microcontroller which handles power, timing, analogue/digital conversion and communications, and an ultrasonic transmitter and associated electronics. The sensor is powered by a battery and an ON switch enables the battery to be connected to the sensor to power the sensor, immediately before the conductor is driven into the ground. The battery life will be between 24 and 76 hours, preferably about 48 hours, and once the battery is exhausted, the sensor will no longer be active. No OFF switch is required, as the sensor will remain in the ground, in the position to which the conductor is driven.

The sensor and battery will preferably be housed in a hermetically sealed steel housing. The housing will preferably be circular so that the angle of the sensor relative to the vertical can be adjusted before the steel housing is welded into position in a recess in the drive shoe wall.

The sensor preferably transmits via ultrasound into the conductor wall, and the ultrasound signals are picked up by a receiver unit mounted at the top end of the conductor. The receiver unit then transmits data to a separate display.

Preferably the or each cavity is sealed to protect the or each orientation sensor received within the or each cavity. Further preferably, the or each orientation sensor comprises a communications interface for communication with a control means for a conductor installation process. Preferably, the or each orientation sensor comprises a communications interface which, in use, transmits vibrational signals through the conductor.

According to a second aspect of the present invention there is provided a method of installing a conductor, the method comprising the steps of:
a) inserting one or more orientation sensors into the conductor;
b) lowering the conductor to the seabed;
c) driving the conductor into the seabed in a desired direction; and
d) using the data provided by the one or more orientation sensors to monitor the directional installation carried out in step c).

### BRIEF DESCRIPTION OF THE DRAWINGS

The invention will now be further described, by way of example, with reference to the accompanying drawings, in which:

FIG. 1 is a schematic depiction of an oil or gas drilling platform;

FIG. 2 is a schematic depiction of conductors that are installed into the soil formation below the sea bed;

FIG. 3 shows a portion of a drive shoe that is located at the end of a directionally driven conductor, with part of the wall cut away to show the mounting of the sensor;

FIG. 4 shows the internal components of the sensor;

FIG. 5 is a schematic depiction of the sensor system according to the present invention transmitting sensor data to the driving process control unit; and

FIG. 6 is a schematic depiction of a preferred embodiment of the present invention

### DETAILED DESCRIPTION

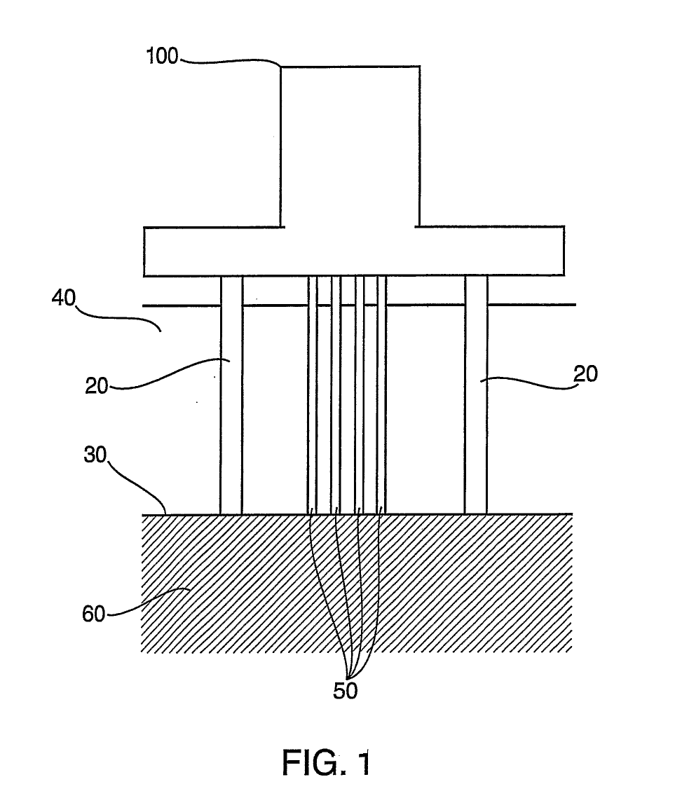

FIG. 1 shows a schematic depiction of an oil or gas drilling/production platform 100 that is supported on the sea bed 30 by a number of legs 20; these legs may rest on the seabed 30 or extend into the soil formation 60 found below the seabed. The legs also support the drilling platform above the surface of the sea 40 to reduce the risk of damage to the platform from wave impacts, etc. Oil is extracted from the soil formation by driving a plurality of conductors into the soil formation 60. Typically an oil platform will have many conductors, for example in excess of 6. Although not shown in the Figure, each of the conductors will be supporting or connected to, other items of equipment including, at different stages in the operation of the platform, drilling risers, blow out preventers (BOPs), subsea trees, production risers, etc.

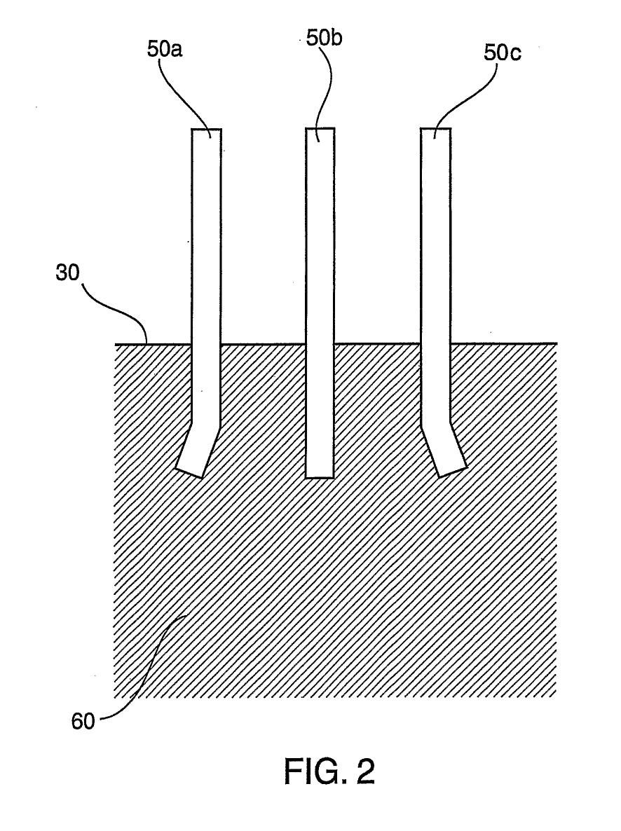

To mitigate the problems of conductors colliding with, or interfering with, adjacent conductors it is known to use directional driving techniques to install conductors. FIG. 2 shows a schematic depiction of a plurality of conductors 50 that are installed into the soil formation 60 below the sea bed 30. In this case, conductor 50b has been installed in a substantially vertical orientation whilst conductors 50a and 50c have been installed using a directional technique that guides the conductors away from the central conductor 50b.

Despite the sophistication of directional driving techniques, conductors do not always follow their intended course when being driven into the sea bed. If a conductor deviates from its intended course, it can interfere or collide with adjacent conductors. This unwanted deviation is often caused by unexpected soil conditions or by the conductors not being correctly aligned prior to the driving process. In order to prevent this from happening, it is known to drive one joint, or section, of conductor at a time and to then survey the installation to check that it is proceeding according to plan. This can become very expensive due to the cost of running a drill bit into the conductor, cleaning out, carrying out a survey and checking the path of the new conductor prior to continuing driving operation from a drilling rig or platform.

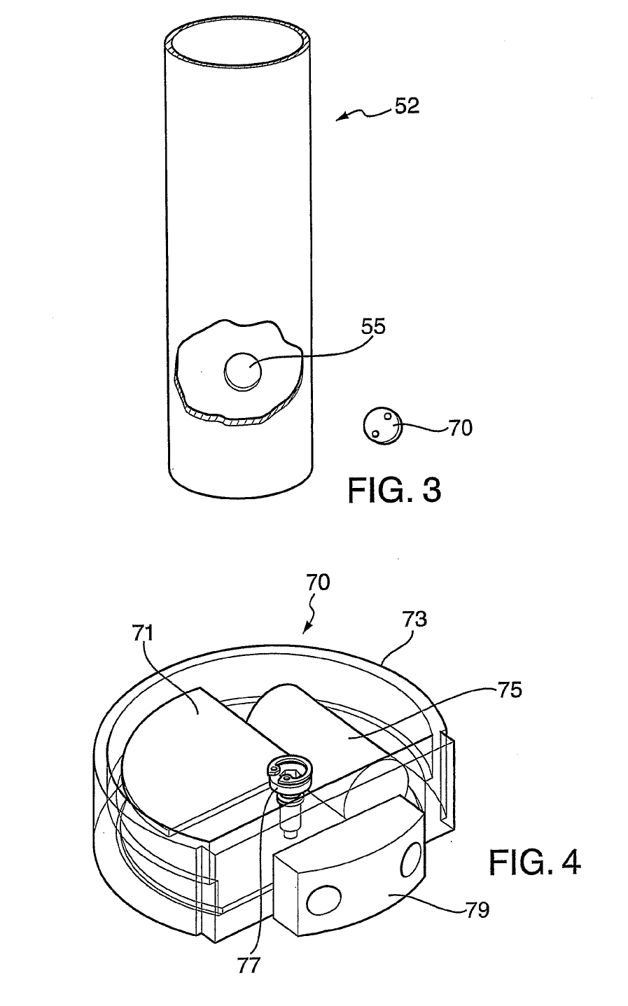

FIG. 3 shows a schematic depiction of a portion of a drive shoe 52 that is located at the end of a directionally driven conductor. The drive shoe has a hollow cylindrical form and a cylindrical cavity 55 is formed within the internal wall of the drive shoe. An orientation sensor 70 unit is shown apart from the cavity in FIG. 3, but is to be fitted within the cavity. It is possible for the cavity and the sensor to have mating threads, so that the unit can be screwed into the cavity. It is important that the orientation of the unit in the cavity be adjustable, so that the sensor can be correctly oriented before it is permanently fixed in one position in the drive shoe wall. The sensor unit comprises one or more sensors that detect the orientation (inclination and azimuth) of the drive shoe and a communications interface that can transmit this orientation data back to the control unit 80 of the driving process at the surface (see FIG. 5). If this data indicates that the conductor is not following its intended course, remedial action can be taken, for example by well intervention.

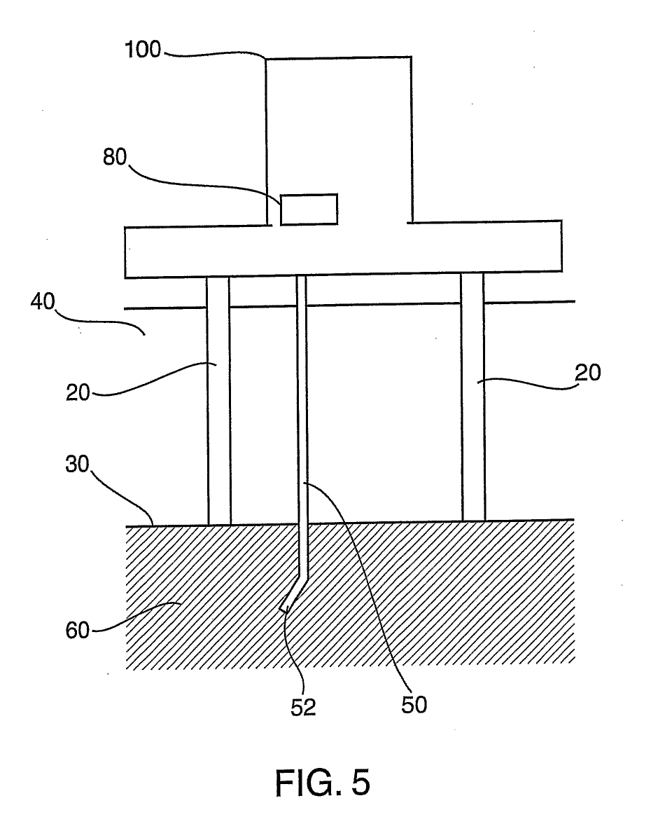

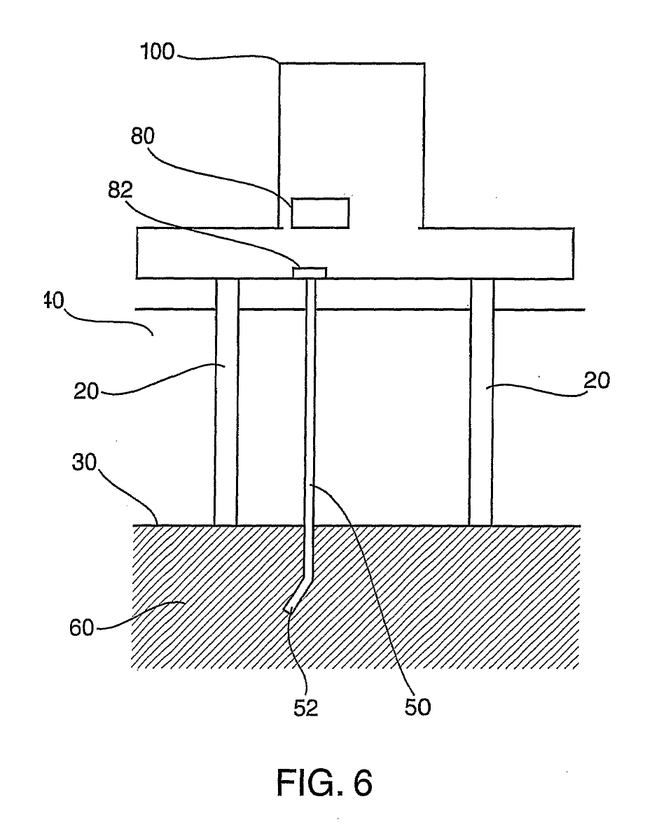

FIG. 4 shows more detail of the sensor unit 70. A sensor 71 is mounted within a circular enclosure 73, together with a battery 75. An ON switch 77 allows power from the battery to be provided to the sensor, and the sensor sends an output to a piezo-ceramic transducer 79 which introduces an ultrasound signal into the wall of the drive shoe. The components shown in FIG. 4 are sealed into a hermetically closed steel enclosure, and will be encapsulated in a suitable encapsulation compound to prevent them being damages by shock waves. The enclosure 73 is sealed and encapsulated in a continuous cylindrical steel case which is welded closed.

In use, when the sensor unit has been fitted in the cavity 55 and driving of the conductor is ready to begin, the switch 77 is operated so that the sensor starts emitting ultrasound signals along the length of the conductor. These signals continue until the battery life expires, after around 48 hours, by which time the conductor will have reached its final position. The sensor unit is thereafter non-functional. Typically, signals will be sent every two minutes.

The battery can be a lithium primary cell.

The inclination and azimuth data as sensed by the sensor 70 will be related to the vertical axis of the conductor. Thus the conductor 50b shown in FIG. 2 which is following a truly vertical path will have an inclination of zero and an azimuth of zero.

Preferably, the received orientation data can be combined with the data generated from the driving process that indicates how far the drive shoe has been driven into the sea bed to give an accurate indication of the direction and orientation of the conductor. If this indicated position shows that the drive shoe has deviated from the desired direction and thus there is a risk that it may collide with another conductor, or take the position that is intended for another conductor, then the operator may be able to alter the directional driving process to reduce the deviation from the desired direction. Alternatively, the indicated position of the drive shoe may be fed to the directional driving as a part of a feedback loop that controls the installation of the drive shoe.

Once the orientation sensor 70 is fitted within the cavity within the drive shoe then it will be necessary to cover the cavity to protect the sensor from the marine environment. As the sensor will not be required to operate following the installation of the conductor, it can be battery powered and thus there is no need to provide power to the sensor. However the sensor and its battery power will be required to be very robust, as the process of driving the conductor involves very heavy hammer impacts on the top end of the conductor, which impacts travel through the wall of the conductor.

The sensors may comprise a plurality of gyroscopes, or other sensing devices. For the purposes of redundancy, it may be desired to install more than one orientation sensor into a drive shoe. The orientation sensors may be fitted into a single cavity or they may be distributed at different points around the circumference of the drive shoe.

FIG. 5 shows a schematic depiction of a preferred embodiment of the present invention. In this embodiment the orientation sensor(s) include a communications interface that sends information to a receiver unit 82 that is coupled to the upper end of the conductor. The information is sent by causing vibrations to propagate through the body of the conductor, for example as sonic or ultrasonic signals. These signals are received by the receiver unit 82 which then relays the orientation data to the control unit 809, via a wireless or cable connection. The orientation sensor(s) are secured within the cavity within the body of the conductor, using an epoxy resin or similar fixative, to ensure that there is a suitable coupling between the sensor(s) and the conductor to enable the signals to propagate through the conductor.

The conductor is installed in sections, and the process of connecting a new section to the section that has been installed takes a short period of time, typically a few minutes. This period is preferably used as a window in which the direction of the conductor and/or its deviation from the intended direction can be determined. This information can then be used in the installation of the next section of conductor. It is thought likely that it would be difficult to successfully receive data from an orientation sensor when a conductor section was being installed due to the vibrations that are caused by the driving of the conductor. The orientation sensors may be put into a sleep mode during the installation process and then activated, by sending an appropriate control signal, to sense and report the directional data whilst a new section of conductor is connected.

It should be understood that although the foregoing discussion relates to the use of the present invention with the directional driving of a conductor, the present invention is equally suited for use with other conductor installation techniques where it is useful or beneficial to determine the position and/or orientation of a conductor.

1. A well conductor for subsea installation, the conductor comprising an orientation sensor, the orientation sensor comprising one or more sensor means for, in use, determining the orientation of the conductor when being installed.

2. A well conductor according to claim 1, wherein the sensor senses both inclination of the conductor and azimuthal orientation of the conductor.

3. A conductor as claimed in claim 1, wherein the sensor also senses penetration depth.

4. A conductor as claimed in claim 1, wherein the sensor comprises a 2D inclination sensor.

5. A conductor as claimed in claim 4, wherein the sensor is a bi-axial accelerometer which can measure ±15° from the vertical in two orthogonal planes.

6. A conductor as claimed in claim 1, wherein the sensor is mounted in a sealed housing with a microcontroller, an ultrasonic transmitter and a battery with an ON switch

7. A conductor as claimed in claim 6, wherein the housing is a hermetically sealed circular steel housing.

8. A conductor as claimed in claim 1, wherein the sensor transmits via ultrasound into the conductor wall, and the ultrasound signals are picked up by a receiver unit mounted at the top end of the conductor.

9. A conductor as claimed in claim 1, having a drive shoe at its leading end, wherein the sensor is mounted in the drive shoe.

10. A method of installing a conductor, the method comprising the steps of:
a) inserting one or more orientation sensors into the conductor;
b) lowering the conductor to the seabed;
c) driving the conductor into the seabed in a desired direction; and
d) using the data provided by the one or more orientation sensors to monitor the directional installation carried out in step c).
